(19) United States
(12) Patent Application Publication
(10) Pub. No.: US 2021/0103296 A1
(43) Pub. Date: Apr. 8, 2021

(54) UNMANNED AERIAL VEHICLE FOR INVENTORY MANAGEMENT AND METHOD OF OPERATING THE SAME

(71) Applicant: Samsung Electronics Co., Ltd., Suwon-si (KR)

(72) Inventors: Minsu LEE, Suwon-si (KR); Sunggu KWON, Suwon-si (KR); Woong KWON, Suwon-si (KR); Sanghyeon KIM, Suwon-si (KR); Junho PARK, Suwon-si (KR); Jongbeom HER, Suwon-si (KR)

(21) Appl. No.: 17/061,454

(22) Filed: Oct. 1, 2020

(30) Foreign Application Priority Data
Oct. 2, 2019 (KR) 10-2019-0122292

(51) Int. Cl. G05D 1/10; B64C 39/02; B64F 1/36; B64D 27/24; G08G 5/00; G06Q 10/08

(52) U.S. Cl. CPC G05D 1/101; B64C 39/024; B64F 1/362; B64D 27/24; B64C 2201/141; G06Q 10/087; B64C 2201/027; B64C 2201/042; B64C 2201/12; G08G 5/0034

(57) ABSTRACT

An embodiment disclosed herein relates to an unmanned aerial vehicle for inventory management and a method of operating the same. The unmanned aerial vehicle may include: at least one sensor configured to acquire at least one of inertia information or position information of the unmanned aerial vehicle; a communication unit configured to communicate with a control system; and a processor operably connected to the at least one sensor and the communication unit. The processor may be configured to: receive an inventory survey request from the control system; generate a route information of the unmanned aerial vehicle based on the received request and previously stored spatial information; and perform an inventory survey based on the generated route information.

### CROSS-REFERENCE TO RELATED APPLICATION

This application is based on and claims priority under 35 U.S.C. 119 to Korean Patent Application No. 10-2019-0122292, filed on Oct. 2, 2019, in the Korean Intellectual Property Office, the disclosure of which is herein incorporated by reference in its entirety.

### BACKGROUND

### 1. Field

Embodiments disclosed herein relate to an unmanned aerial vehicle for inventory management and a method of operating the same.

### 2. Description of Related Art

An unmanned aerial vehicle (UAV) refers to an airplane or helicopter-type vehicle that is unmanned and flies through guidance of radio waves.

Unmanned aerial vehicles originated in the military industry, but as unmanned aerial vehicles began to be used commercially, research thereon is also actively being progressed. In particular, unmanned aerial vehicles have been applied in various fields such as exploration and broadcasting leisure, in addition to military use, due to advantages such as simplicity, speed, and economy.

Recently, with the emergence of unmanned aerial vehicles that are capable of detecting an object using a camera, a sensor, or the like, and have rapid mobility, the scope of application of unmanned aerial vehicles has expanded to industrial fields such as distribution, transportation, warehouse management, and inventory surveys.

The above information is presented as background information only to assist with an understanding of the disclosure. No determination has been made, and no assertion is made, as to whether any of the above might be applicable as prior art with regard to the disclosure.

### SUMMARY

In general, the unmanned aerial vehicles, which have been applied to the industrial field, are capable of autonomous driving based on GPS data. However, there are restrictions on the use of the unmanned aerial vehicles indoors where it is difficult to obtain GPS data. For example, in order to carry out an inventory survey in a large indoor space such as a material warehouse, there is a problem in that it is necessary for a user to carry an unmanned aerial vehicle directly to a survey site and to directly control the unmanned aerial vehicle.

Recently, in order to overcome the technical disadvantages described above, a method of attaching a sensor (e.g., a lidar, a laser scanner, a radar, or a camera) capable of detecting terrain features to an unmanned aerial vehicle has been proposed. Specifically, a scheme of generating a 3D map using sensors attached to an unmanned aerial vehicle and recognizing the position of the unmanned aerial vehicle in the generated 3D map has been proposed. However, in the scheme described above, there are problems in that the sensors used to generate the 3D map are expensive, and that, in a larger target area, the distance to fly for the inventory survey is long, and thus it is impossible to smoothly perform the inventory survey with the limited battery capacity of the unmanned aerial vehicle.

The technical subjects pursued in the disclosure may not be limited to the above mentioned technical subjects, and other technical subjects which are not mentioned may be clearly understood, through the following descriptions, by those skilled in the art to which the disclosure pertains.

An unmanned aerial vehicle (UAV) according to an embodiment disclosed herein may include: at least one sensor configured to acquire at least one of inertia information or position information of the unmanned aerial vehicle; a communication unit configured to communicate with a control system; and a processor operably connected to the at least one sensor and the communication unit. The processor may be configured to: receive an inventory survey request from the control system; generate a route information of the unmanned aerial vehicle based on the received request and previously stored spatial information; and perform an inventory survey based on the generated route information.

A method of operating an unmanned aerial vehicle (UAV) according to an embodiment may include: receiving an inventory survey request from a control system; generating a route information of the unmanned aerial vehicle based on the received request and previously stored spatial information; and performing an inventory survey based on the generated route information.

The unmanned aerial vehicle according to an embodiment is capable of autonomously traveling in a survey place by generating an optimal movement route therefor based on an inventory object and previously stored spatial information, and performing an inventory survey based on the generated movement route. In addition, the unmanned aerial vehicle according to an embodiment is capable of reducing a distance required to fly for an inventory survey and reducing power consumption thereof by generating an optimal movement route and performing an inventory survey based on the optimal movement route.

Effects obtainable from the disclosure may not be limited to the above mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an inventory management system according to an embodiment;

FIG. 2 is a perspective view of an unmanned aerial vehicle according to an embodiment;

FIG. 3 is a view illustrating an autonomous-traveling operation of an unmanned aerial vehicle according to an embodiment;

FIG. 4 is a view illustrating a charging station for an unmanned aerial vehicle according to an embodiment;

FIG. 5 is a view illustrating the components of an unmanned aerial vehicle according to an embodiment;

FIG. 6 is a flowchart illustrating an operation for performing an inventory survey using an unmanned aerial vehicle according to an embodiment;

FIG. 7 is a flowchart illustrating an operation for generating route information in an unmanned aerial vehicle according to an embodiment;

FIG. 8A is a view for describing an operation of generating route information in an unmanned aerial vehicle according to an embodiment, and FIG. 8B is a view for describing an operation of generating route information in an unmanned aerial vehicle according to an embodiment;

FIG. 9A is a flowchart illustrating an operation for determining an order of movement to survey points in an unmanned aerial vehicle according to an embodiment;

FIG. 9B is a view for describing an operation of determining a survey direction in an unmanned aerial vehicle according to an embodiment;

FIG. 10 is a flowchart illustrating an operation for performing an inventory survey using an unmanned aerial vehicle according to an embodiment; and

FIG. 11 is a flowchart illustrating an operation for performing a charging mode during an inventory survey using an unmanned aerial vehicle according to an embodiment.

### DETAILED DESCRIPTION

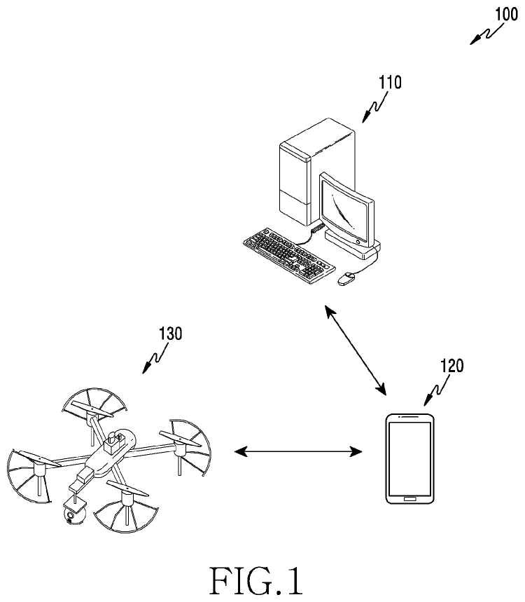

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, an embodiment of the disclosure will be described in detail in conjunction with the accompanying drawings. In describing embodiments of the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

FIG. 1 is a view illustrating an inventory management system 100 according to an embodiment.

Referring to FIG. 1, the inventory management system 100 may include a distribution management system 110, a control system 120, and an unmanned aerial vehicle 130.

According to an embodiment, the distribution management system 110 can handle overall management of a distribution center such as a material warehouse. For example, the distribution management system 110 can manage a procedure leading to warehousing, storage, classification, and shipment of goods.

According to an embodiment, the distribution management system 110 can instruct the unmanned aerial vehicle 130 to perform monitoring within the distribution center. Monitoring may involve an inventory survey for at least one article (or goods) loaded in the distribution center, and can be performed by the unmanned aerial vehicle 130. For example, the monitoring instruction can include information on a survey object. For example, the information on a survey object can include at least one of items of a survey object item (e.g., article names) and information on loading of survey objects (e.g., information on a loading rack or information on a pallet). In addition, the distribution management system 110 can provide a monitoring instruction to the unmanned aerial vehicle 130 through the control system 120. However, this is merely an example, and the embodiment is not limited thereto. For example, the monitoring instruction can be provided directly from the distribution management system 110 to the unmanned aerial vehicle 130 without going through the control system 120.

According to an embodiment, the distribution management system 110 can receive a monitoring result from the unmanned aerial vehicle 130. For example, the distribution management system 110 can determine the inventory of articles based on the monitoring result. For example, the monitoring result can be received through the control system 120. However, this is merely an example, and the embodiment is not limited thereto. For example, the monitoring result can be directly received from the unmanned aerial vehicle 130 without going through the control system 120.

According to an embodiment, the control system 120 can process information exchange between the distribution management system 110 and the unmanned aerial vehicle 130. According to an embodiment, the control system 120 can communicate with the distribution management system 110 based on a first communication protocol, and can communicate with the unmanned aerial vehicle 130 based on a second communication protocol, which is identical to or different from the first communication protocol. For example, the control system 120 request an inventory survey from the unmanned aerial vehicle 130 based on the monitoring instruction received from the distribution management system 110. In addition, the control system 120 can provide a monitoring result provided from the unmanned aerial vehicle 130 to the distribution management system 110.

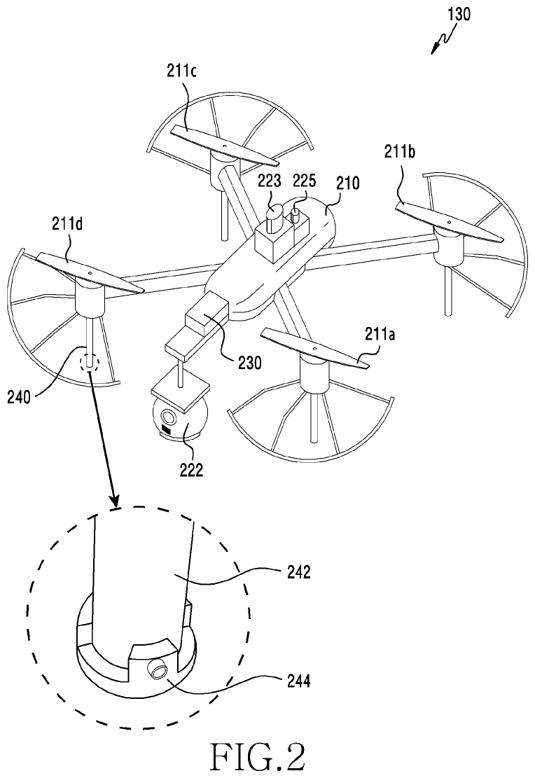

According to an embodiment, the unmanned aerial vehicle 130 can be an electronic device capable of autonomously traveling, as will be described later with reference to FIG. 2. For example, the unmanned aerial vehicle 130 is an electronic device capable of autonomously traveling (or flying) in a horizontal or vertical direction, and may be, for example, a drone. However, this is merely an example, and the embodiment is not limited thereto. For example, the unmanned aerial vehicle 130 can be capable of traveling in various directions, and can be capable of traveling through a user's manipulation.

According to an embodiment, in response to receiving the monitoring instruction, the unmanned aerial vehicle 130 can monitor at least some spaces in the distribution center. For example, the unmanned aerial vehicle 130 can perform an inventory survey on a survey object based on the information on the survey object included in the monitoring instruction.

According to an embodiment, the distribution management system 110 and the control system 120 can be configured separately from each other, as illustrated in the drawing. However, this is merely an example, and the embodiment is not limited thereto. For example, the distribution management system 110 and the control system 120 can be an integrated structure.

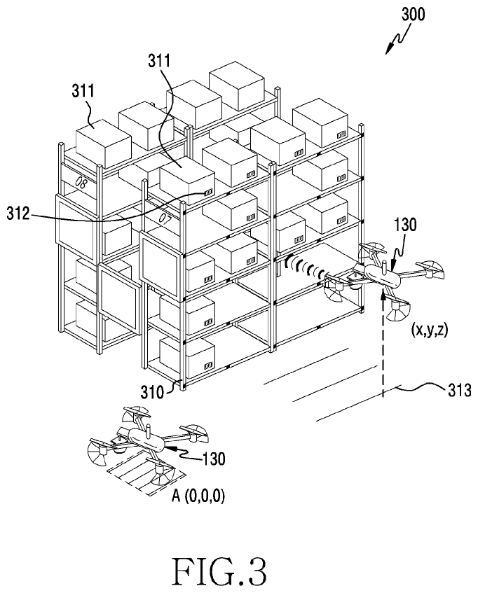

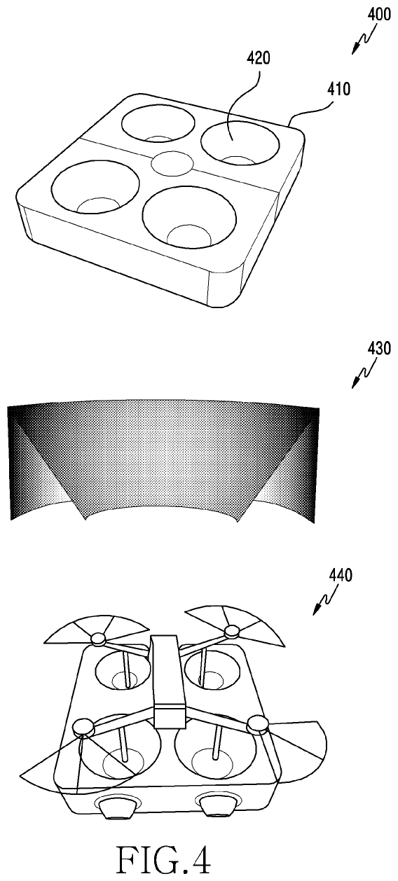

FIG. 2 is a perspective view of an unmanned aerial vehicle 130 according to an embodiment. In addition, FIG. 3 is a view 300 illustrating an autonomous traveling operation of an unmanned aerial vehicle 130 according to an embodiment, and FIG. 4 is a view 400 illustrating a charging station 410 of an unmanned aerial vehicle 130 according to an embodiment.

Referring to FIG. 2, the unmanned aerial vehicle 130 according to an embodiment can include a body 210, one or more driving units 211a, 211b, 211c, and 211d, one or more sensors 222, 223, and 225, a barcode reader 230, and at least one support structure 240.

According to an embodiment, a first driving unit 211a, a second driving unit 211b, a third driving unit 211c, and a fourth driving unit 211d can be attached to the body 210 of the unmanned aerial vehicle 130. For example, each of the driving units 211a, 211b, 211c, and 211d can include at least one propeller. For example, the unmanned aerial vehicle 130 can travel (or fly) in a horizontal or vertical direction by rotation of at least one of the propellers. According to an embodiment, the first driving unit 211a and the third driving unit 211c, which are located in one diagonal direction with respect to the body 210, and the second driving unit 211b and the fourth driving unit 211d, which are located in another diagonal direction with respect to the body 210, can operate in pairs. However, this is merely an example, and the embodiment is not limited thereto. For example, the first driving unit 211a, the second driving unit 211b, the third driving unit 211c, and the fourth driving unit 211d can be driven independently of each other.

According to an embodiment, the barcode reader 230 is attached to the body 210 of the unmanned aerial vehicle 130, and can recognize a barcode attached to a specific position of an article. The unmanned aerial vehicle 130 can determine the quantity or position information of articles loaded in the rack through the barcode reader 230 during an autonomous traveling process.

According to an embodiment, the one or more sensors 222, 223, and 225 can be mounted inside or outside the unmanned aerial vehicle 130. According to an embodiment, the one or more sensors 222, 223, and 225 can acquire traveling information of the unmanned aerial vehicle 130. For example, the at least one sensors 222, 223, and 225 can include an inertial sensor 221 capable of acquiring inertial information such as acceleration and angular velocity of the unmanned aerial vehicle 130, a tag recognition sensor 222 capable of recognizing a tag attached inside a distribution center, and an image sensor 223 capable of acquiring an image of a traveling environment of the unmanned aerial vehicle 130 during a traveling (or flying) process. For example, the inertial sensor 221 can be an inertial measurement unit (IMU), and the tag recognition sensor 222 can be a camera capable of tag recognition. In addition, the image sensor 223 can be at least one of a 2D lidar, a 3D lidar, an RGB-D sensor, and a camera, but is not limited thereto.

According to an embodiment, the support structure 240 can be a structure configured to support the weight of the unmanned aerial vehicle 130 when the unmanned aerial vehicle 130 is taking off or landing or is running or mooring. According to an embodiment, the at least one support structure 240 can include a hollow body 242 and a charging terminal 244 coupled to the hollow body 242. For example, the hollow body 242 and the charging terminal 244 can include threads to be coupled to each other by rotation. However, this is merely an example, and the embodiment is not limited thereto. For example, the hollow body 242 and the charging terminal 244 can be combined in various ways. In addition, the charging terminal 244 can be electrically connected to a battery mounted inside or outside the unmanned aerial vehicle 130. At least one component (e.g., an electric wire) for electrical connection between the charging terminal 244 and the battery can be disposed inside the hollow body 242. In addition, the charging terminal 244 can come into contact with an electrode member on a charging station 410 so as to charge the battery, as will be described later with reference to FIG. 4.

According to an embodiment, as illustrated in FIG. 3, the unmanned aerial vehicle 130 autonomously travels indoors along a corridor 313, and can survey the inventory of loaded articles 311 in a fixed place, such as a “rack” 310). According to an embodiment, the unmanned aerial vehicle 130 can fly while grasping absolute position information and/or relative position information of the unmanned aerial vehicle 130 using the one or more sensors 222, 223, and 225 described above. For example, the unmanned aerial vehicle 130 can estimate the current driving (or flying) position indoors based on the sensing values of the one or more sensors 222, 223, and 225 without additional GPS data. For example, the unmanned aerial vehicle 130 can set the travel-start position (e.g., area A in FIG. 3) as the origin (0, 0, 0), and can represent an indoor area in which the unmanned aerial vehicle 130 travels as a world coordinate system. In addition, the unmanned aerial vehicle 130 can estimate the current position thereof based on the sensing values of the one or more sensor 222, 223, and 225 and can represent the current position as coordinate data (x, y, z).

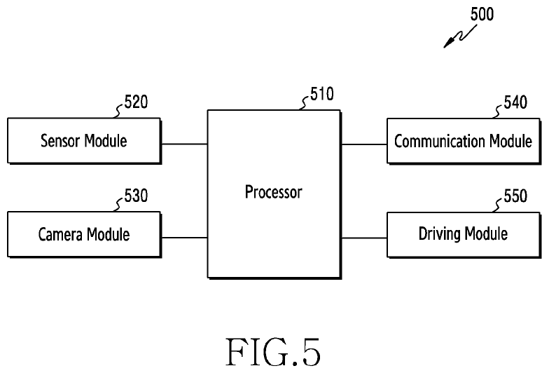

According to an embodiment, as will be described later with reference to FIG. 5, the unmanned aerial vehicle 130 can generate route information using a survey object included in the monitoring instruction as a stopping area, and can then perform an inventory survey based on the generated route information. The route information can indicate a movement route that allows the unmanned aerial vehicle 130 to survey the inventory of articles 311 loaded on racks 310 located at opposite sides of a corridor 313 in the distribution center while traveling along the corridor 313, as illustrated in FIG. 3. In addition, the route information can indicate a movement route that allows the unmanned aerial vehicle 130 to survey only the inventory of articles 311 loaded at a specific position of a rack 310.

According to an embodiment, the unmanned aerial vehicle 130 can operate in a charging mode while performing an inventory survey. The charging mode can be a mode in which the unmanned aerial vehicle 130 temporarily stops the inventory survey, which is being performed, returns to the charging station 410, and performs charging. According to an embodiment, the charging station 410 can include one or more electrode members configured to come into contact with the charging terminals 244 of the unmanned aerial vehicle 130, as illustrated in FIG. 4. According to an embodiment, the charging station 410 can include one or more accommodation spaces 420, each extending upward from a lower portion of the charging station 410, and each of the electrode members can be formed in at least a portion of one of the accommodation spaces 420 (e.g., the bottom and/or side of the corresponding accommodation space 420). In this case, as illustrated in the view 430 in FIG. 4, each of the accommodation spaces 420 can have a first inclination angle in the lower portion thereof and a second inclination angle greater than the first inclination angle toward the top thereof. Due to the structure of the accommodation spaces 420, as illustrated in the view 440 in FIG. 4, the support structures 240 (e.g., the charging terminals 244) of the unmanned aerial vehicle 130 can be stably seated in the accommodation spaces 420 in the charging station 410.

FIG. 5 is a view 500 illustrating the components of an unmanned aerial vehicle 130 according to an embodiment.

Referring to FIG. 5, the unmanned aerial vehicle 130 can include a processor 510, a sensor module 520, a camera module 530, a communication module 540, and a driving module 550, as illustrated in the drawing. However, this is only exemplary, and the embodiment is not limited thereto. For example, the unmanned aerial vehicle 130 can further include various components such as a memory, a battery, and a display device.

According to an embodiment, the sensor module 520 and the camera module 530 can correspond to the one or more sensors 222, 223, and 225 described above with reference to FIG. 2. According to an embodiment, the sensor module 520 can include at least one sensor capable of acquiring inertial information such as acceleration and angular velocity of the unmanned aerial vehicle 130. According to an embodiment, the camera module 530 can acquire a tag attached in the distribution center and an image of the traveling environment of the unmanned aerial vehicle 130.

According to an embodiment, the communication module 540 can support establishing a communication channel between the unmanned aerial vehicle 130 and the control system 120 and performing communication through the established communication channel. According to an embodiment, the communication module 540 can include a cellular communication module and/or a short-range wireless communication module.

According to an embodiment, the driving module 550 can correspond to the driving units 211a, 211b, 211c, and 211d described above with reference to FIG. 2. According to an embodiment, there can be at least one driving module 550.

According to an embodiment, the processor 510 can generate route information using a survey object included in an inventory survey instruction as a stopping area. According to an embodiment, the processor 510 can generate an optimal movement route of the unmanned aerial vehicle 130 based on the survey object and previously stored spatial information. For example, the processor 510 can check at least one of the name of a survey object, information on a rack on which the survey object is loaded, and information on the position of the survey object in the loading rack (e.g., a pallet or a tray). In addition, the processor 510 can set at least one loading rack on which a survey object is loaded as a survey point, and can generate route information including a survey route through which the unmanned aerial vehicle moves from each survey point to a position of a survey object. In addition, the processor 510 can determine the survey order of loading racks when a plurality of loading racks are set as survey points. For example, the processor 510 can determine the survey order using the remaining battery capacity and distances from the current position of the unmanned aerial vehicle 130 to survey points.

According to an embodiment, in response to generating route information, the processor 510 can perform an inventory survey based on the generated route information. According to an embodiment, the processor 510 can perform an inventory survey inside the distribution center by operating the driving module 550, for example, the one or more driving units 211a, 211b, 211c, and 211d.

According to an embodiment, the processor 510 can provide an inventory survey result to the distribution management system 110 while performing the inventory survey. For example, the processor 510 can control the communication module 540 to provide the inventory survey result to the distribution management system 110.

According to an embodiment, the processor 510 can cause the unmanned aerial vehicle 130 to operate in a charging mode while performing the inventory survey. As described above, the charging mode can be a mode in which the unmanned aerial vehicle 130 temporarily stops the inventory survey, which is being performed, returns to the charging station 410, and performs charging. For example, the processor 510 can control the unmanned aerial vehicle 130 to operate in a charging mode and to return to a predetermined charging station 410 in response to identifying that the remaining battery capacity is less than a threshold value.

An unmanned aerial vehicle (e.g., the unmanned aerial vehicle 130) can include: at least one sensor (e.g., the one or more sensors 222, 223, and 225) configured to acquire at least one of inertia information or position information of the unmanned aerial vehicle; a communication unit (e.g., the communication module 540) configured to communicate with a control system; and a processor (e.g., the processor 510) operably connected to the at least one sensor and the communication unit. The processor can be configured to: receive an inventory survey request from the control system (e.g., the control system 120); generate a route information of the unmanned aerial vehicle based on the received request and previously stored spatial information; and perform an inventory survey based on the generated route information.

According to an embodiment, the processor can be configured to cause the unmanned aerial vehicle to return to a charging station in response to identifying a first predetermined remaining battery capacity while the inventory survey is being performed.

According to an embodiment, the processor can be configured to resume the inventory survey in response to identifying a second predetermined remaining battery capacity after the unmanned aerial vehicle returns to the charging station.

According to an embodiment, the processor can be configured to move the unmanned aerial vehicle to a position at which the unmanned aerial vehicle was located before returning to the charging station in response to resuming the inventory survey.

According to an embodiment, the inventory survey request can include at least one of an item to be surveyed, information on loading of the item to be surveyed, or a quantity of the item to be surveyed. In addition, the loading information can include at least one of information on a rack on which the item to be surveyed is loaded and information on a pallet on which the item to be surveyed is loaded.

According to an embodiment, the processor can be configured to generate information associated with at least one loading rack on which an item to be surveyed is loaded, and route information including a movement route from an entrance of the loading rack to the item to be surveyed loaded on the loading rack.

According to an embodiment, the processor can be configured to determine an order of movement to the loading rack based on a remaining battery capacity of the unmanned aerial vehicle.

According to one embodiment, the processor can be configured to generate a movement route having a shortest distance to the item to be surveyed loaded on the loading rack.

According to one embodiment, the processor can be configured to determine an order of movement to the loading rack based on a loaded amount of the item to be surveyed.

According to one embodiment, the processor can be configured to cause the unmanned aerial vehicle to perform autonomous flight based on the generated route information.

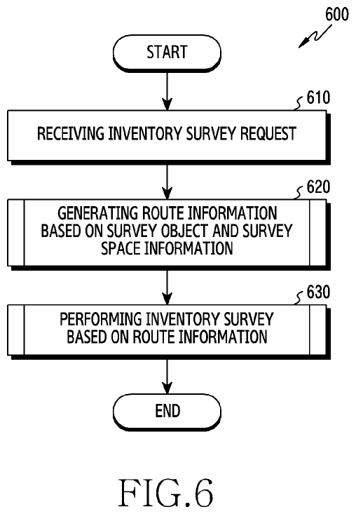

FIG. 6 is a flowchart (600) illustrating an operation for performing an inventory survey using an unmanned aerial vehicle 130 according to an embodiment. In the following embodiments, respective operations may be performed sequentially, but are not necessarily performed sequentially. For example, the order of respective operations may be changed, and at least two operations may be performed in parallel.

Referring to FIG. 6, according to an embodiment, an unmanned aerial vehicle 130 (e.g., the processor 510 in FIG. 5) can receive an inventory survey request in operation 610. The inventory survey request can include a survey object item (e.g., article names) and loading information on the survey object (e.g., information on a loading rack or information on a pallet). According to an embodiment, the inventory survey request can be received through the control system 120 or the distribution management system 110.

TABLE 1

| Article Name | Loading Rack | Loading Position | Quantity |
|---|---|---|---|
| A | #1 | (1-4)ₜₕ pallet | 3 boxes |
| B | #1 | (1-7)ₜₕ pallet | 1 box |
| C | #3 | (3-1)ₜₕ pallet | 5 boxes |

For example, referring to Table 1, the inventory survey request can indicate surveys for Article A for which 3 boxes are loaded on a (1-4)th pallet of a first loading rack (#1), Article B for which 1 box is loaded on a (1-7)th pallet of the first rack (#1), and Article C for which 5 boxes are loaded on a (3-1)th pallet of the third loading rack (#3).

According to an embodiment, in operation 620, the unmanned aerial vehicle 130 (e.g., the processor 510 of FIG. 5) can generate route information based on a survey object and spatial information based on the inventory survey request. According to an embodiment, the spatial information can be information associated with a space in the distribution center and at least one rack arranged in the distribution center. Such spatial information can be stored in the unmanned aerial vehicle 130 or can be provided from the outside (e.g., the distribution management system 110 or the control system 120). For example, the processor 510 can generate route information using only the rack on which the survey object is loaded as a stopping area.

According to an embodiment, the unmanned aerial vehicle 130 (e.g., the processor 510 of FIG. 5) can perform an inventory survey based on the route information in operation 630. According to an embodiment, the processor 510 can perform autonomous traveling based on route information, and can move to a specific position of articles corresponding to a survey object for the inventory survey. In addition, the processor 510 can recognize a barcode attached to the moved position and can grasp the quantity or position information of the articles loaded on the corresponding rack. For example, the processor 510 can use the one or more sensors 222, 223, and 225 to perform autonomous driving. For example, the processor 510 can recognize a space in the distribution center by defining an object in a 3D data type (e.g., a voxel type) based on a received signal reflected from the object in the distribution center.

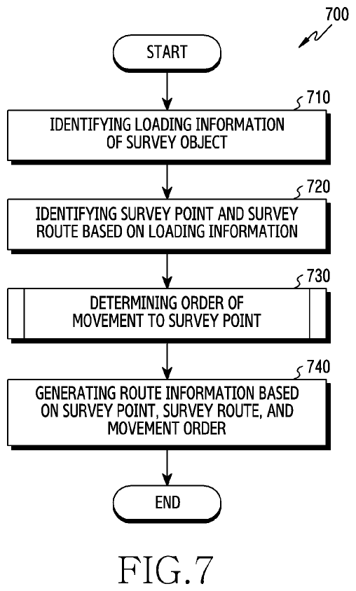

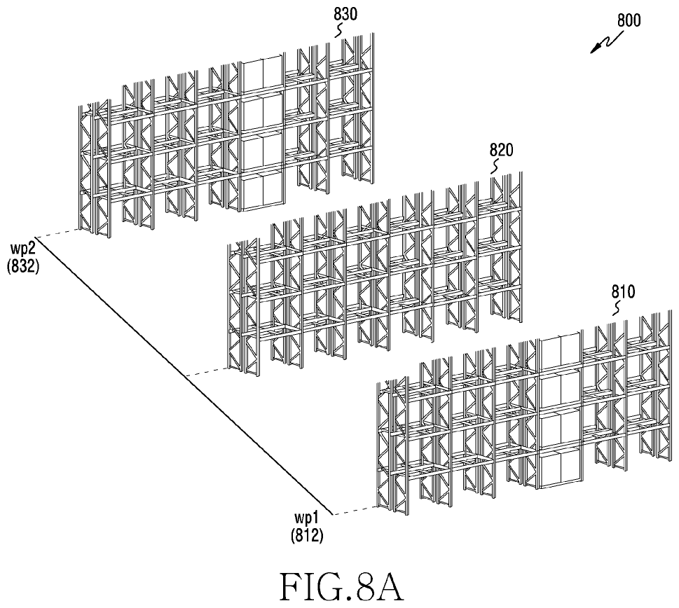

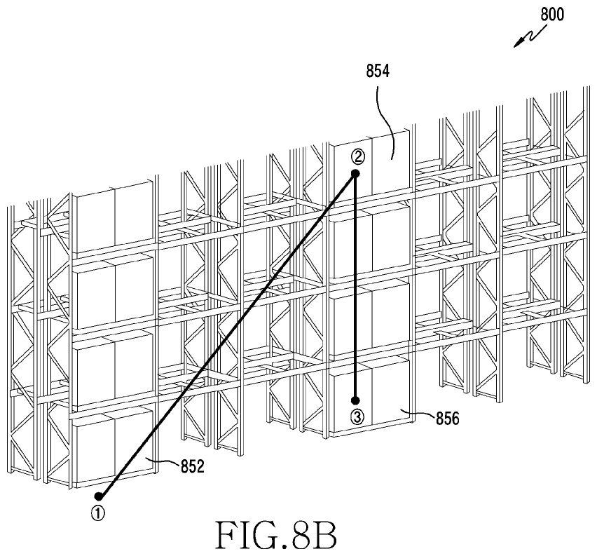

FIG. 7 is a flowchart (700) illustrating operations for generating route information in the unmanned aerial vehicle 130 according to an embodiment. In addition, FIGS. 8A and 8B are views 800 for explaining an operation of generating route information in the unmanned aerial vehicle 130 according to an exemplary embodiment. The operations of FIG. 7 to be described below may correspond to various embodiments of operation 620 in FIG. 6. In the following embodiments, respective operations may be performed sequentially, but are not necessarily performed sequentially. For example, the order of respective operations may be changed, and at least two operations may be performed in parallel.

Referring to FIG. 7, according to an embodiment, the unmanned aerial vehicle 130 (e.g., the processor 510 in FIG. 5) can acquire loading information on a survey object in operation 710. The loading information can be associated with the loading position of the survey object. According to an embodiment, the processor 510 can identify information on a rack on which the survey object is loaded, and position information on a position (e.g., a pallet or a tray) at which the survey object is located in the loading rack.

According to an embodiment, the unmanned aerial vehicle 130 (e.g., the processor 510 in FIG. 5) can identify the survey point and the survey route based on the loading information in operation 720. The survey point can be a position of a rack on which the survey object is loaded among the racks arranged in the distribution center. For example, as illustrated in FIG. 8A, among a first rack 810, a second rack 820, and a third rack 830 arranged in the distribution center, the processor 510 can identify the rack 810 and the third rack 830, on which the survey object is loaded, as a first survey point (wp1) 812 and a second survey point (wp2) 832, respectively. For example, a survey point can be an entrance to a corridor through which the corresponding rack can be entered. In addition, a survey route can be a route along which the unmanned aerial vehicle 130 moves from a survey point to a position at which a survey object is loaded. For example, as illustrated in FIG. 8B, the processor 510 can identify a survey route for moving from the first survey point (wp1) 812 to the positions of a first survey object 852, a second survey object 854, and a third survey object 856 in order (\textcircled{1}→\textcircled{2}→\textcircled{3}). For example, the processor 510 can identify a survey route along which the unmanned aerial vehicle 130 moves to the first survey object 852, the second survey object 854, and the third survey object 856 in the shortest distance. In addition, the processor 510 can also identify the survey route to the second survey point (wp2) 832.

According to an embodiment, the unmanned aerial vehicle 130 (e.g., the processor 510 in FIG. 5) can determine the order of movement to the survey points in operation 730. For example, the processor 510 can determine the order of movement to the survey point such that the movement distance of the unmanned aerial vehicle 130 becomes the shortest distance. For example, the processor 510 can set the closest survey position (wp1) 812 from the position of the unmanned aerial vehicle 130 as a start position, and can determine the order for sequentially moving to the next survey position (wp2) 832. Alternatively, the processor 510 can set the farthest survey position (wp2) 832 from the position of the unmanned aerial vehicle 130 as a start position, and can determine the order for sequentially moving to the next survey position (wp1) 812. As another example, the processor 510 can determine the order of movement to the survey point based on the loaded amount of the survey object. For example, when the first rack on which one survey object is loaded, the third rack on which three survey objects are loaded, and the fifth rack on which two survey objects are loaded are determined as survey positions, the processor 510 can determine the third rack on which the largest number of survey objects are loaded as a survey start position, and one of the first rack or the fifth rack as the next survey position.

According to an embodiment, in operation 740, the unmanned aerial vehicle 130 (e.g., the processor 510 in FIG. 5) can generate route information including a survey point, a survey route, and a movement order. In addition, after generating the route information, the processor 510 can perform an inventory survey based on the route information.

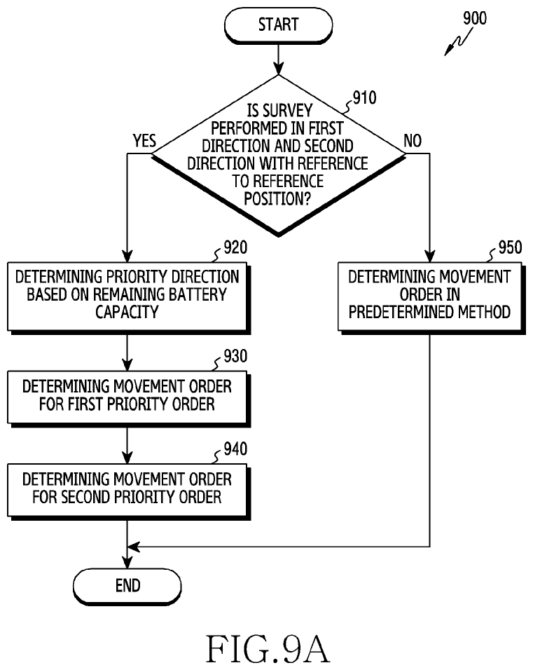

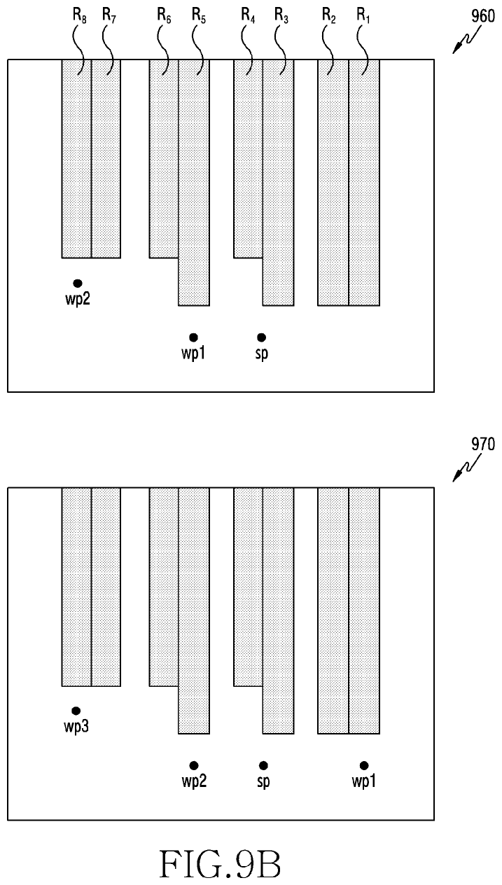

FIG. 9A is a flowchart (900) illustrating operations for determining the order of movement to a survey point by the unmanned aerial vehicle 130 according to an embodiment. In addition, FIG. 9B illustrates views (960) and (970) for explaining operations for determining a survey direction in the unmanned aerial vehicle 130 according to an embodiment. The operations of FIG. 9A to be described below may correspond to an embodiment of operation 730 in FIG. 7. In the following embodiments, respective operations may be performed sequentially, but are not necessarily performed sequentially. For example, the order of respective operations may be changed, and at least two operations may be performed in parallel.

Referring to FIG. 9A, according to an embodiment, the unmanned aerial vehicle 130 (e.g., the processor 510 in FIG. 5) can determine whether to perform the survey in a first direction (or a second direction) or in the first direction and the second direction based on a reference position in operation 910. The reference position can be associated with the current position of the unmanned aerial vehicle 130.

According to an embodiment, the unmanned aerial vehicle 130 (e.g., the processor 510 in FIG. 5) can perform an operation associated with operation 950 when a determination is made that the survey is performed in the first direction or the second direction. For example, when the survey is performed in the first direction or the second direction, as illustrated in the view 960 of FIG. 9B, a situation may exist in which, among the racks arranged in the distribution center, the racks on which survey objects are loaded (e.g., R5 and R8) are present only in the first direction (e.g., the left position) or only in the second direction (e.g., the right direction) with reference to the current position (sp) of the unmanned aerial vehicle 130. According to an embodiment, in operation 950, the processor 510 can determine the order of movement to the survey point in a predetermined manner. For example, the processor 510 can set the closest survey position (wp1) from the position of the unmanned aerial vehicle 130 as a start position, and can determine the order for sequentially moving to the next survey position (wp2). Alternatively, the processor 510 can set the farthest survey position (wp2) 832 from the position of the unmanned aerial vehicle 130 as a start position, and can determine the order for sequentially moving to the next survey position (wp1) 812.

According to an embodiment, the unmanned aerial vehicle 130 (e.g., the processor 510 in FIG. 5) can perform operations associated with operations 920 to 940 when a determination is made that the survey is performed in the first direction and the second direction. For example, when the survey is performed in the first direction (or the second direction), as illustrated in the view 970 of FIG. 9B, a situation can exist in which, among the racks arranged in the distribution center, the racks on which survey objects are loaded (e.g., R2, R5, and R8) are present in the first direction and the second direction with reference to the current position (sp) of the unmanned aerial vehicle 130. According to an embodiment, in operation 920, the processor 510 can determine one of the first direction or the second direction as a priority direction based on a remaining battery capacity. For example, when a determination is made that movement of the unmanned aerial vehicle 130 to the rack on which a survey object is loaded is arranged in the first direction using the current remaining battery capacity is possible, the processor 510 can determine the first direction as the priority direction. For example, when a determination is made that movement of the unmanned aerial vehicle 130 to the rack on which a survey object is loaded is arranged in the first direction using the current remaining battery capacity in impossible, the processor 510 can determine the second direction in which the number of racks on which survey objects are loaded is relatively smaller than that in the first direction, as the priority direction.

According to an embodiment, the unmanned aerial vehicle 130 (e.g., the processor 510 in FIG. 5) can determine the order of movement to the survey points in the first priority direction in operation 930. According to an embodiment, the processor 510 can determine the order of movement of the unmanned aerial vehicle 130 to the racks which are present in the first direction.

According to an embodiment, the unmanned aerial vehicle 130 (e.g., the processor 510 in FIG. 5) can determine the order of movement to the survey points in the second priority direction in operation 940. According to an embodiment, the processor 510 can determine the order of movement of the unmanned aerial vehicle 130 to the racks which are present in the second direction. In addition, the processor 510 can generate route information based on the determined order of movement to the survey point.

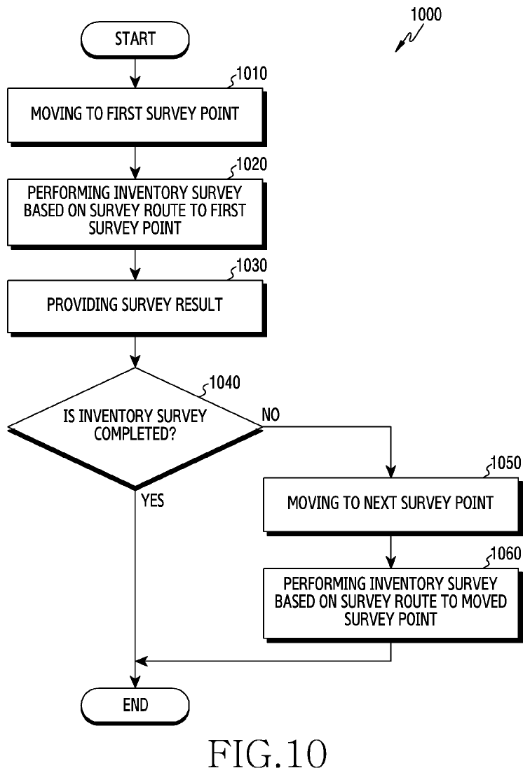

FIG. 10 is a flowchart (1000) illustrating operations for performing an inventory survey using the unmanned aerial vehicle 130 according to an embodiment. The operations of FIG. 10 described below may correspond to an embodiment of operation 630 in FIG. 6. In the following embodiments, respective operations may be performed sequentially, but are not necessarily performed sequentially. For example, the order of respective operations may be changed, and at least two operations may be performed in parallel.

Referring to FIG. 10, according to an embodiment, the unmanned aerial vehicle 130 (e.g., the processor 510 in FIG. 5) can move to a first inventory survey point in operation 1010. According to an embodiment, the first survey point can be a position of a rack at which an inventory survey is first started by the unmanned aerial vehicle 130.

According to an embodiment, the unmanned aerial vehicle 130 (e.g., the processor 510 in FIG. 5) can perform an inventory survey based on the survey route to the first survey point in operation 1020. According to an embodiment, the processor 510 can cause the unmanned aerial vehicle 130 to move to a position at which an inventory survey object is loaded based on the survey route. For example, the processor 510 can set the first survey point to be a survey start position and can cause the unmanned aerial vehicle 130 to recognize the barcode of the survey object while moving to the position at which the inventory survey object is loaded.

According to an embodiment, the unmanned aerial vehicle 130 (e.g., the processor 510 in FIG. 5) can provide an inventory survey result to the distribution management system 110 in operation 1030. According to an embodiment, the processor 510 can directly provide the inventory survey result to the distribution management system 110 or can provide the inventory survey result to the distribution management system 110 through the control system 120.

According to an embodiment, in operation 1040, the unmanned aerial vehicle 130 (e.g., the processor 510 in FIG. 5) can determine whether or not the inventory survey is completed. According to an embodiment, the processor 510 can determine whether or not a inventory survey is performed on all of the racks on which survey objects are loaded.

According to an embodiment, the unmanned aerial vehicle 130 (e.g., the processor 510 in FIG. 5) can complete the inventory survey operation when determined that the inventory survey is completed. For example, the processor 510 can cause the unmanned aerial vehicle 130 to return to the charging station 410.

According to an embodiment, when determined that the inventory survey is not completed, the unmanned aerial vehicle 130 (e.g., the processor 510 in FIG. 5) can move to the next survey point in operation 1050. According to an embodiment, the unmanned aerial vehicle 130 (e.g., the processor 510 in FIG. 5) can perform an inventory survey based on the survey route along which the unmanned aerial vehicle 130 has moved to the survey point, in operation 1060. According to an embodiment, the processor 510 can repeatedly perform an operation of performing an inventory survey and an operation of providing a result until the inventory survey is completed.

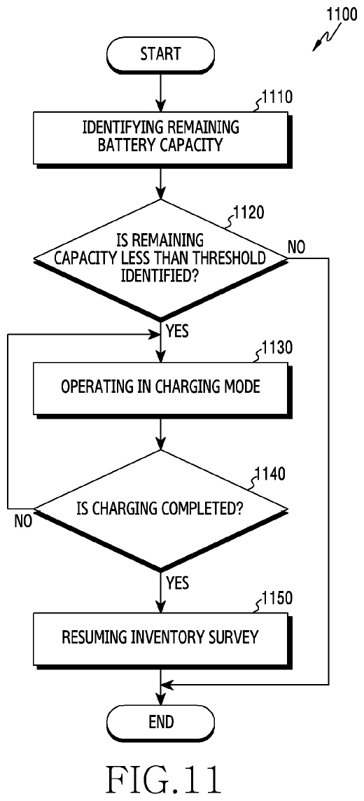

FIG. 11 is a flowchart (1100) illustrating operations for performing a charging mode during the inventory survey using the unmanned aerial vehicle 130 according to an embodiment. The operations of FIG. 11 described below may correspond to an embodiment of operation 630 in FIG. 6. In the following embodiments, respective operations may be performed sequentially, but are not necessarily performed sequentially. For example, the order of respective operations may be changed, and at least two operations may be performed in parallel.

Referring to FIG. 11, according to an embodiment, the unmanned aerial vehicle 130 (e.g., the processor 510 in FIG. 5) can identify the remaining battery capacity of the unmanned aerial vehicle 130 in operation 1110. According to an embodiment, the processor 510 can identify the remaining battery capacity while the unmanned aerial vehicle 130 performs an inventory survey.

According to an embodiment, in operation 1120, the unmanned aerial vehicle 130 (e.g., the processor 510 in FIG. 5) can determine whether or not the remaining battery capacity is less than a predetermined threshold. For example, the predetermined threshold can be a reference value for determining whether to suspend the inventory survey performed using the unmanned aerial vehicle 130. According to an embodiment, the predetermined threshold can be a remaining battery capacity that allows the unmanned aerial vehicle 130 to fly from the current position to the charging station 410.

According to an embodiment, the unmanned aerial vehicle 130 (e.g., the processor 510 in FIG. 5) can maintain the execution of the inventory survey when the remaining battery capacity equal to or more than the threshold value or more is identified.

According to an embodiment, when the remaining battery capacity less than the threshold is identified, the unmanned aerial vehicle 130 (e.g., the processor 510 in FIG. 5) can operate in a charging mode in operation 1130. According to an embodiment, the charging mode can be a mode in which the unmanned aerial vehicle 130 temporarily stops the inventory survey, which is being performed, returns to the charging station 410, and performs charging. For example, the processor 510 can cause the unmanned aerial vehicle 130 to return to the charging station 410 based on the predetermined position information of the charging station 410.

According to an embodiment, the unmanned aerial vehicle 130 (e.g., the processor 510 in FIG. 5) can determine whether or not the completion of charging of the unmanned aerial vehicle 130 is detected in operation 1140. According to an embodiment, the completion of charging can be the state in which the unmanned aerial vehicle is charged to be capable of returning to the charging station 410 after resuming the inventory survey for a survey object for which the inventory survey has not been performed.

According to an embodiment, the unmanned aerial vehicle 130 (e.g., the processor 510 in FIG. 5) can maintain the charging operation when the completion of charging is not detected. According to an embodiment, the processor 510 can determine whether or not resuming the inventory survey while identifying the state of charge of the battery is possible.

According to an embodiment, the unmanned aerial vehicle 130 (e.g., the processor 510 in FIG. 5) can resume the inventory survey in operation 1150 when the completion of charging is detected. According to an embodiment, the processor 510 can move the unmanned aerial vehicle 130 to a position at which an investigation object for which an inventory survey has not been performed is loaded.

According to an embodiment, a method of operating an unmanned aerial vehicle (UAV) (e.g., the unmanned aerial vehicle 130) can include: receiving an inventory survey request from a control system; generating a route information of the unmanned aerial vehicle based on the received request and previously stored spatial information; and performing an inventory survey based on the generated route information.

According to an embodiment, the method of operating an unmanned aerial vehicle can further include causing the unmanned aerial vehicle to return to a charging station in response to identifying a first predetermined remaining battery capacity while the inventory survey is being performed.

According to an embodiment, the method of operating an unmanned aerial vehicle can further include resuming the inventory survey in response to identifying a second predetermined remaining battery capacity after the unmanned aerial vehicle returns to the charging station.

According to an embodiment, the method of operating an unmanned aerial vehicle can further include moving the unmanned aerial vehicle to a position at which the unmanned aerial vehicle was located before returning to the charging station in response to resuming the inventory survey.

According to an embodiment, the inventory survey request can include at least one of an item to be surveyed, information on loading of the item to be surveyed, or a quantity of the item to be surveyed. In addition, the loading information can include at least one of information on a rack on which the item to be surveyed is loaded and information on a pallet on which the item to be surveyed is loaded.

According to an embodiment, the route information can include information associated with at least one loading rack on which an item to be surveyed is loaded, and a movement route from an entrance of the loading rack to the item to be surveyed loaded on the loading rack.

According to an embodiment, the method of operating an unmanned aerial vehicle can further include determine an order of movement to the loading rack based on a remaining battery capacity of the unmanned aerial vehicle.

According to an embodiment, the method of operating an unmanned aerial vehicle can further include generating a movement route having the shortest distance to the item to be surveyed loaded on the loading rack.

According to an embodiment, the method of operating an unmanned aerial vehicle can further include determining an order of movement to the loading rack based on a loaded amount of the item to be surveyed.

According to an embodiment, the method of operating an unmanned aerial vehicle can further include performing the inventory survey through autonomous flight based on the generated route information.

Machines according to an embodiment (e.g., the distribution management system 110, the control system 120, and the unmanned aerial vehicle 130) can be various types of devices. The machines can include, for example, a portable communication device (e.g., a smart phone), a computer device, a portable multimedia device, a portable medical device, a camera, a wearable device, or a home appliance. The machines according to an embodiment are not limited to the above-described example.

It should be appreciated that various embodiments of the disclosure and the terms used therein are not intended to limit the technological features set forth herein to particular embodiments and include various changes, equivalents, and/or alternatives for a corresponding embodiment. With regard to the description of the drawings, similar reference numerals may be used to designate similar or relevant elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., program) including one or more instructions that are stored in a storage medium (e.g., internal memory or external memory) that is readable by a machine (e.g., the unmanned aerial vehicle 130). For example, a processor (e.g., the processor 510) of the machine (e.g., the unmanned aerial vehicle 130) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

Although various embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. An unmanned aerial vehicle comprising:
at least one sensor configured to acquire at least one of inertia information or position information of the unmanned aerial vehicle;
a communication unit configured to communicate with a control system; and
a processor operably connected to the at least one sensor and the communication unit, wherein the processor is configured to:
receive an inventory survey request from the control system,
generate a route information of the unmanned aerial vehicle based on the received request and previously stored spatial information, and
perform an inventory survey based on the generated route information.

2. The unmanned aerial vehicle of claim 1, wherein the processor is further configured to:
cause the unmanned aerial vehicle to return to a charging station in response to identifying a first predetermined remaining battery capacity while the inventory survey is being performed.

3. The unmanned aerial vehicle of claim 2, wherein the processor is further configured to:
resume the inventory survey in response to identifying a second predetermined remaining battery capacity after the unmanned aerial vehicle returns to the charging station.

4. The unmanned aerial vehicle of claim 3, wherein the processor is further configured to:
move the unmanned aerial vehicle to a position at which the unmanned aerial vehicle was located before returning to the charging station in response to resuming the inventory survey.

5. The unmanned aerial vehicle of claim 1, wherein:
the inventory survey request comprises at least one of an item to be surveyed, information on loading of the item to be surveyed, or a quantity of the item to be surveyed, and
the loading information comprises at least one of information on a rack on which the item to be surveyed is loaded and information on a pallet on which the item to be surveyed is loaded.

6. The unmanned aerial vehicle of claim 1, wherein the processor is further configured to:
generate information associated with at least one loading rack on which an item to be surveyed is loaded and the route information comprising a movement route from an entrance of the loading rack to the item to be surveyed loaded on the loading rack.

7. The unmanned aerial vehicle of claim 6, wherein the processor is further configured to:
determine an order of movement to the loading rack based on a remaining battery capacity of the unmanned aerial vehicle.

8. The unmanned aerial vehicle of claim 6, wherein the processor is further configured to:
generate a movement route having a shortest distance to the item to be surveyed loaded on the loading rack.

9. The unmanned aerial vehicle of claim 6, wherein the processor is further configured to:
determine an order of movement to the loading rack based on a loaded amount of the item to be surveyed.

10. The unmanned aerial vehicle of claim 1, wherein the processor is further configured to:
cause the unmanned aerial vehicle to perform autonomous flight based on the generated route information.

11. A method of operating an unmanned aerial vehicle, the method comprising:
receiving an inventory survey request from a control system;
generating a route information of the unmanned aerial vehicle based on the received request and previously stored spatial information; and
performing an inventory survey based on the generated route information.

12. The method of claim 11, further comprising:
causing the unmanned aerial vehicle to return to a charging station in response to identifying a first predetermined remaining battery capacity while the inventory survey is being performed.

13. The method of claim 12, further comprising:
resuming the inventory survey in response to identifying a second predetermined remaining battery capacity after the unmanned aerial vehicle returns to the charging station.

14. The method of claim 13, further comprising:
moving the unmanned aerial vehicle to a position at which the unmanned aerial vehicle was located before returning to the charging station in response to resuming the inventory survey.

15. The method of claim 11, wherein:
the inventory survey request comprises at least one of an item to be surveyed, information on loading of the item to be surveyed, or a quantity of the item to be surveyed, and
the loading information comprises at least one of information on a rack on which the item to be surveyed is loaded and information on a pallet on which the item to be surveyed is loaded.

16. The method of claim 11, wherein the route information comprises information associated with at least one loading rack on which an item to be surveyed is loaded, and a movement route from an entrance of the loading rack to the item to be surveyed loaded on the loading rack.

17. The method of claim 16, further comprising:
determining an order of movement to the loading rack based on a remaining battery capacity of the unmanned aerial vehicle.

18. The method of claim 16, further comprising:
generating a movement route having a shortest distance to the item to be surveyed loaded on the loading rack.

19. The method of claim 16, further comprising:
determining an order of movement to the loading rack based on a loaded amount of the item to be surveyed.

20. The method of claim 11, further comprising:
performing the inventory survey through autonomous flight based on the generated route information.
